(19) United States
(12) Patent Application Publication
(10) Pub. No.: US 2004/0089227 A1
(43) Pub. Date: May 13, 2004

(54) Dual chamber vacuum processing system

(76) Inventor: Albert Wang, Moraga, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/624,728

(22) Filed: Jul. 21, 2003

Related U.S. Application Data
(60) Provisional application No. 60/397,592, filed on Jul. 19, 2002.

(51) Int. Cl. B05C 11/00

(52) U.S. Cl. 118/47; 118/663; 118/684; 438/906

(57) ABSTRACT

A photoresist ashing system includes two processing chambers configured for alternate operation in processing substrates. The system includes a single pump that performs both pump-down and process pumping of both of the chambers. In operation, one of the chambers is pumped down and processed while the other chamber is vented, unloaded and re-loaded.

### CROSS REFERENCE TO RELATED APPLICATIONS

This application claims the benefit of U.S. Provisional Patent Application Ser. No. 60/397,592, filed on Jul. 19, 2002, the entire contents of which is incorporated herein by reference and made part of the present disclosure.

### FIELD OF THE INVENTION

The present invention relates to dual chamber vacuum processing systems for processing semiconductor wafers and other substrates and, more particularly, to the sharing of hardware resources in such systems.

### BACKGROUND OF THE INVENTION

Dual chamber vacuum processing systems have been developed in which certain hardware components are shared between the processing chambers. The idea is that, by sharing components between the chambers, the total cost of the system can be reduced without significantly adversely affecting wafer throughput. Examples of such dual chamber processing systems are disclosed in U.S. Pat. No. 6,228,773, issued May 8, 2001 to Cox, and U.S. Pat. No. 6,273,956, issued Aug. 14, 2001, both of which are incorporated herein by reference and made part of the present disclosure.

A pumping system of an exemplary dual chamber vacuum processing system of the above patents is illustrated schematically in FIG. 1. The system of FIG. 1 generally includes two processing chambers 10, 12 which are both served by a single microwave source (not shown) that can be switched between the chambers 10, 12. The system includes two vacuum pumps 20, 22. A pump down pump 20 is operated to evacuate the chambers 10, 12 prior to processing.

A process pump 22 is operated to evacuate the chambers 10, 12 during processing. Vacuum lines 26 connect the pumps 20, 22 to the chambers 10, 12. Isolation valves 30, 32, 34, 36 are provided in the vacuum lines 26 to selectively isolate the pumps 20, 22 from the chambers 10, 12, as desired. For example, when a substrate is undergoing a process in the chamber 10, and the chamber 12 is undergoing pump down, the isolation valves 32 and 36 are open, and the isolation valves 30, 34 are closed. When a substrate is undergoing a process in the chamber 12, and the chamber 10 is undergoing pump down, the isolation valves 30 and 34 are open, and the isolation valves 32, 36 are closed. A throttle valve 40 is provided upstream of the process pump 22 to regulate pressure in the chamber 10, 12 in which a substrate is being processed.

In operation, while one of the chambers 10, 12 is processing, the other chamber 10, 12 is vented, unloaded of a processed substrate, loaded with a fresh substrate, and pumped down. If all of these overhead operations can be performed while the first chamber 10, 12 is processing, the microwave source can be switched to the other chamber 10, 12 immediately after the first chamber 10, 12 is finished processing. Accordingly, the microwave source is fully utilized and, ideally, there is no system overhead time in which processing is not occurring in one of the chambers 10, 12.

To achieve this “zero overhead” operating condition, however, the system of FIG. 1 requires four isolation valves 30, 32, 34, 35, two vacuum pumps 20, 22, and a relatively complex system of vacuum lines 26. These components, and especially the pumps 20, 22 can be relatively expensive. In addition, the pump down pump 20 is not fully utilized, because the actual pump down process constitutes only a relatively small proportion of the total overhead time.

### SUMMARY OF THE INVENTION

Accordingly, a need exists for a dual chamber vacuum processing system in which additional components are shared to reduce cost without significantly adversely affecting wafer throughput.

In accordance with one embodiment of the present invention, a photoresist ashing system is provided. The system includes two processing chambers configured for alternate operation and a single pump that performs both pump down and process pumping of both of the chambers.

In accordance with another embodiment of the present invention, a dual chamber processing system for continuously processing a plurality of workpieces comprises a common power source switchable between a first plasma applicator of a first chamber and a second plasma applicator of a second chamber. The first chamber is configured for processing a second workpiece in a vacuum to completion therein when the power source is applied to the first plasma applicator and switched ON. A robot is provided for removing at substantially atmospheric pressure a first workpiece from the second chamber after processing and reloading the second chamber with a third workpiece to be processed while the second workpiece is being processed in the first chamber. The second chamber is configured for processing the third workpiece in a vacuum to completion therein when the power source is applied to the second plasma applicator and switched ON. The robot is configured for removing at substantially atmospheric pressure the second workpiece from the first chamber after processing and reloading the first chamber with a fourth workpiece to be processed while the third workpiece is being processed in the second chamber. Exactly one pump is provided and adapted to be in fluid communication with the first and second chambers. The pump is configured to perform both process pumping and pump-down (evacuation) pumping of both chambers. Additionally, a computer can be provided and configured to repeatedly synchronously and alternately control the power source application, the robot movement, the chamber processing, and the pumping.

In accordance with another embodiment of the present invention, a method is provided for processing substrates in a processing apparatus. The method comprises providing a first processing chamber, a second processing chamber; and a single a vacuum pump adapted to selectively communicate with the first processing chamber via a first vacuum line, and with the second processing chamber via a second vacuum line. The method further comprises alternately pumping the first and second chambers with the single pump.

According to an alternative embodiment, a method further comprises providing a first isolation valve in said first vacuum line, and a second isolation valve in said second vacuum line. The method includes opening the first isolation valve in the first vacuum line, pumping down the first processing chamber with the pump and processing a first substrate in the first processing chamber. The method further provides for unloading a second substrate from the second processing chamber. According to another embodiment, the method further comprises loading a third substrate into the second processing chamber, closing the first isolation valve in the first vacuum line, opening the second isolation valve in the second vacuum line, and pumping down the second processing chamber with the pump after completing the processing of the first substrate. Finally, the third substrate is processed in the second processing chamber.

### BRIEF DESCRIPTION OF THE DRAWINGS

FIG. 1 is a simplified schematic diagram of a pumping system for a dual chamber substrate processing system of the prior art;

FIG. 2 is a simplified schematic diagram of a pumping system for a dual chamber substrate processing system according to one embodiment of the present invention;

FIG. 3 is a graphical representation of timing of preparation and processing phases using the pumping system of FIG. 1; and

FIG. 4 is a graphical representation of timing of preparation and processing phases using the pumping system of FIG. 2.

### DETAILED DESCRIPTION OF THE PREFERRED EMBODIMENTS

The dual chamber processing system shown and described herein can include many of the components of the systems shown and described in U.S. Pat. Nos. 6,228,773 and 6,273,956. For example, in addition to the components described herein, embodiments of a dual-chamber processing system of the present invention can generally include: a plasma source with a switchable power supply, such as a microwave source or other suitable source; suitable robotic interfaces for loading and unloading wafers and performing other wafer-transfer steps; process gas sources; a venting system for bringing a chamber back to atmospheric pressure after a processing step is complete; and a pumping system for reducing the pressure within the chambers before and during wafer processing. According to one embodiment, the plasma source includes an individual remote plasma applicator associated with each of the chambers. In an alternative embodiment, the plasma source is in situ. Other additional components can also be used as desired.

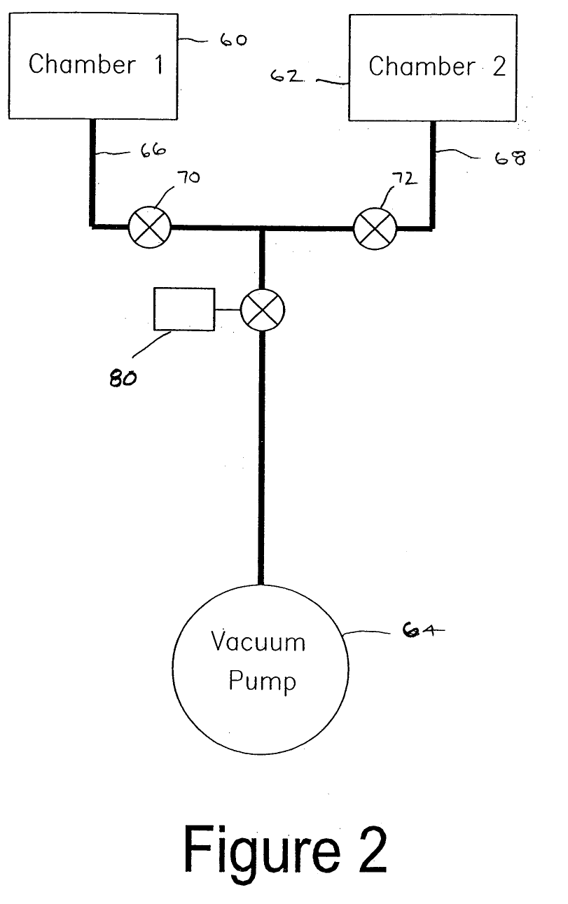

FIG. 2 illustrates one embodiment of a pumping system for a dual chamber substrate processing system. The system of FIG. 2 generally includes a first processing chamber 60 and a second processing chamber 62, which are both served by a single microwave or other power source (not shown) that can be switched between the chambers 60, 62. The illustrated system is designed for synchronously alternating processing of substrates, such that one while one chamber (60 or 62) is performing a processing step, the remaining chamber (60 or 62) can be unloaded of any processed wafers and re-loaded with wafers to be processed. Generally, in the preferred operation of the present system, the processing components operate on only one of the two chambers at any given time.

In the illustrated embodiment, the system has only one vacuum pump 64 configured to serve as both a process pump and a pump-down or evacuation pump for both of the chambers 60, 62. As a pump-down pump, the pump 64 is utilized to rapidly reduce the pressure within the process chamber from atmospheric pressure (about 760 Torr) to a pressure at or near a desired process pressure (usually about 1 Torr) in about 3 to 5 seconds. As a process pump, the pump 64 is used to maintain the chamber at a desired process pressure for the duration of the substrate processing step. Thus, the pump is preferably sized for the maximum required pumping load, which can often be determined from the chamber size, the desired pump-down rate, and other variables. The pump 64 can be either a dry pump (i.e., one that does not require lubrication oil) or a wet pump (i.e., one that does use lubrication oil).

A first vacuum line 66 connects the pump 64 to the first chamber 60. A second vacuum line 68 connects the pump 64 to the second chamber 62. Isolation valves 70, 72 are provided in the vacuum lines 66, 68 to isolate the pump 64 from the chambers 60, 62, as desired. A throttle valve 80 is provided upstream of the pump 64 between the pump 64 and the isolation valves 70, 72 to control a flow rate of gas through the vacuum lines. Additional valves and vacuum lines can also be added as desired, for example, to bypass the throttle valve, etc

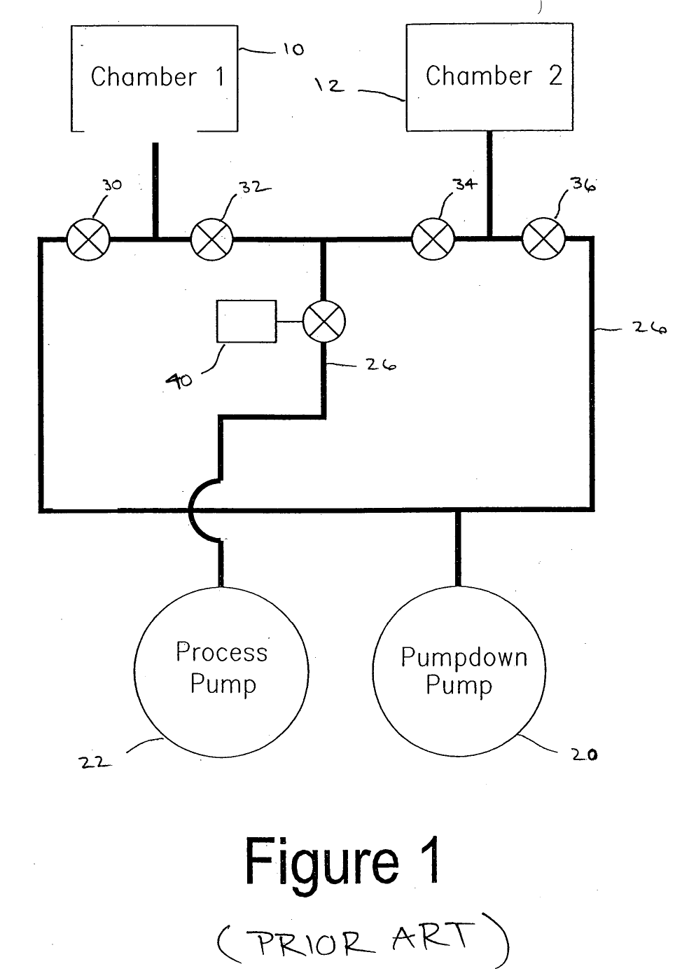

In the system described in U.S. Pat. Nos. 6,228,773 and 6,273,956, the pumping system of which is illustrated schematically in FIG. 1, the steps of venting, unloading, re-loading and pumping down (the ‘preparation phase’) were performed in the first chamber 10 while simultaneously processing wafers (e.g. in a photoresist ashing process) in the second chamber 20 (the ‘processing phase’). Ideally, the processing phase and the preparation phase take exactly the same length of time, thereby creating a “zero overhead condition” by allowing the power source to be switched from one chamber to the other with no idle time.

The inventors have discovered that, in practice, the ideal “zero overhead” operating condition of the previous system is not always achieved because in some situations, the preparation phase takes slightly longer than the processing phase. For example, a given process, such as a photoresist removal process, may take roughly 15 seconds to complete. If the preparation phase also took 15 seconds to complete, the system would be operating at “zero overhead,” and thus the system of FIG. 1 could process 240 substrates per hour. In certain situations, however, the system of FIG. 1 has been found to have a throughput rate of only 200 substrates per hour for a 15 second process, thus implying that the preparation phase can take slightly longer than the processing step.

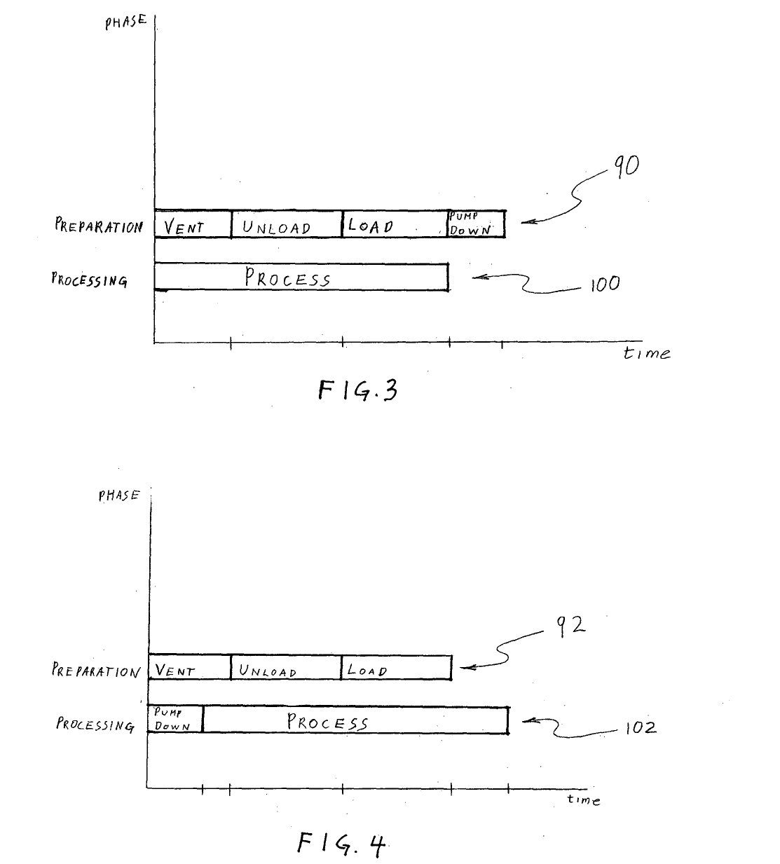

As illustrated graphically in FIG. 3, if the steps carried out in the preparation phase 90 of the first chamber 10 (for example) are not completed when the second chamber 12 finishes its processing phase 100, then the process pump 22 must idle until the first chamber 10 can be transitioned to the processing phase 100. Similarly, in the system of FIGS. 1 and 3, the pump-down pump 20 will remain idle for substantial lengths of time during which it is not needed. These idle times represent a substantial facility expense incurred in operating and maintaining the pumps.

These idle times can be substantially eliminated by switching the pump down procedure from the preparation phase 90 to the processing phase 102 as shown in FIG. 4, thereby providing substantial savings in facility expense as well as allowing for the elimination of a number of costly pumping system components.

The operation of the pumping system embodiments of the present invention will now be described with reference to FIGS. 2 and 4. During the processing phase 102 of the first chamber 60, the isolation valve 70 of the first vacuum line 66 is opened and the isolation valve 72 of the second vacuum line 68 is closed, so that the pump 64 communicates with the first processing chamber 60. The throttle valve 80 can be adjusted to regulate the pressure in the first chamber 60 during processing by controlling a flow rate of gases drawn out of the chamber by the pump 64.

As shown schematically in FIG. 4, During the processing phase 102 of the first chamber 60, the preparation phase 92 of the second chamber 62 is carried out. As shown, the preparation phase 92 includes venting, unloading, and reloading the chamber with a new substrate. Once the processing phase 102 is completed in the first chamber 60, the chambers can transition to their respective opposite phases by closing the isolation valve 70 of the first vacuum line 66 and opening the isolation valve 72 of the second vacuum line 68, so that the pump 64 communicates with the second chamber 62. The processing phase can then begin in the second chamber 62 by pumping down and processing in the second chamber 62. Thus, only one chamber is pumped at a time, and a single pump can serve this function.

During the processing phase 102 in the second chamber 62, the preparation phase is carried out in the first chamber 60 by venting, unloading, and reloading the chamber 60 with a new substrate. By the time the processing phase 102 is completed in the second chamber 62, the preparation phase 92 will be completed in the first chamber 60. The chambers can then be transitioned again and the phases can be repeated.

As described above, the pump down time is effectively subtracted from the total overhead time of the preparation phase 92 and added to the process phase 102. Accordingly, if it takes roughly 3 seconds to pump down one of the chambers 60, 62, and the process time is roughly 15 seconds, the other chamber has 18 seconds to vent, unload, and reload. Thus, the simplified system of FIG. 2 can likely attain nearly the same throughput rate (200 substrates per hour in the example described above) as the more complex and costly system of FIG. 1.

By moving the pump down step from the preparation phase to the processing phase 102, one vacuum pump and two isolation valves of the previous system can be eliminated to provide a substantially less costly system. The layout of the vacuum lines 66, 68 of the system of FIG. 2 is relatively simple, thus further cost savings are associated with a reduction of vacuum lines. As a result, the system of FIG. 2 is cheaper and easier to maintain than the previous system. In addition, while the microwave remote plasma source is not utilized during pump down, the vacuum pump 64, which is relatively expensive, is fully utilized and is never idling.

Thus, the arrangement shown and described herein advantageously allows for elimination of one costly pump relative to prior systems and 100% utilization of the vacuum pump that is present. Thus, both machine cost and facility expense are reduced without sacrificing throughput or process times.

One need not be concerned about connecting both chambers to a single vacuum pump out of fear of interaction when one chamber is processing a wafer and the other chamber begins to pump down from atmosphere, expecting that the burst of air could potentially travel down the vacuum line to the pump and back up to the chamber processing the wafer. The most negative pressure is going to be at the pump head. If the vacuum lines are long enough and big enough in diameter, the pressure will equalize and expand to fill the space.

In the case of ashing, the total process gas flow is on the order of 5 liters per minute for a typical single wafer chamber. Therefore, the gas going through the chamber being processed should be at a higher pressure than what is in the line. The vacuum lines are preferably of sufficient length to provide isolation between the two process chambers. To assist in isolation, the vacuum lines should also be fairly large in diameter to provide more volume for the air to expand from the chamber being pumped down. Furthermore, a bypass valve can be provided with a ¼ inch line to slow the initial burst of air from the chamber being pumped down. A second or two later, the main ISO 80 valve can be opened, thereby providing a higher conductance to rapidly pump the remaining air from the chamber.

Although certain embodiments and examples have been described herein, it will be understood by those skilled in the art that many elements of the methods and devices shown and described in the present disclosure may be differently combined and/or modified to form still further embodiments. Additionally, it will be recognized that the methods described herein may be practiced using any device suitable for performing the recited steps. Such alternative embodiments and/or uses of the methods and devices described above and obvious modifications and equivalents thereof are intended to be within the scope of the present disclosure. Thus, it is intended that the scope of the present invention should not be limited by the particular embodiments described above, but should be determined only by a fair reading of the claims that follow.

What is claimed is:

1. A photoresist ashing system comprising two processing chambers configured for alternate operation and a single pump in fluid communication with the two chambers, the pump being configured to perform both pump down and process pumping of the two chambers.

2. The system of claim 1, further comprising a throttle valve between the single pump and the two chambers, the throttle valve configured to regulate a pressure in at least one of the chambers.

3. The system of claim 1, wherein the single pump is a dry pump.

4. The system of claim 1, wherein the system further comprises only one isolation valve between the pump and a first one of the chambers.

5. The system of claim 4, wherein the system further comprises only one isolation valve between the pump and a second one of the chambers.

6. The apparatus of claim 1, wherein the chambers are adjacent to each other.

7. The apparatus of claim 1, wherein each chamber comprises a remote plasma applicator configured to be powered by a common power source switchable between the first chamber and the second chamber.

8. The apparatus of claim 7, wherein the power supply is microwave.

9. The apparatus of claim 7, wherein the power supply is a common radio frequency power source synchronously multiplexed between the pair of processing chambers.

10. The apparatus of claim 1 wherein the processing chambers are each configured to receive a single silicon wafer at a time, and the processing chambers each comprise a downstream plasma reactor.

11. The apparatus of claim 1 wherein the processing chambers are each configured to receive a single silicon wafer at a time, and the processing chambers each comprise an in-chamber plasma reactor.

12. A dual chamber processing system for continuously processing a plurality of workpieces comprising:
a common power source switchable between a first plasma applicator of a first chamber and a second plasma applicator of a second chamber,
the first chamber for processing a second workpiece in a vacuum to completion therein when the power source is applied thereto and switched ON,
a robot for removing at substantially atmospheric pressure a first workpiece from the second chamber after processing and reloading the second chamber with a third workpiece to be processed while the second workpiece is being processed in the first chamber,
the second chamber for processing the third workpiece in a vacuum to completion therein when the power source is applied to the second plasma applicator and switched ON,
the robot for removing at substantially atmospheric pressure the second workpiece from the first chamber after processing and reloading the first chamber with a fourth workpiece to be processed while the third workpiece is being processed in the second chamber, and
exactly one pump adapted to be in fluid communication with the first and second chambers, the pump being configured to perform both process pumping and pump-down pumping of both chambers;
a computer configured to repeatedly synchronously alternately control the power source application, the robot movement, the chamber processing, and the pump.

13. The apparatus of claim 12, wherein the computer is further configured to open the pump to fluid communication with only one of the chambers at a time.

14. A method of processing substrates in a processing apparatus, the method comprising:
providing a first processing chamber and a second processing chamber;
providing a single vacuum pump adapted to selectively communicate with the first processing chamber via a first vacuum line, and with the second processing chamber via a second vacuum line;
alternately pumping the first and second chambers with the single pump.

15. The method of claim 14, wherein alternately pumping comprises:
providing a first isolation valve in said first vacuum line, and a second isolation valve in said second vacuum line;
opening the first isolation valve in the first vacuum line;
pumping down the first processing chamber with the pump;
processing a first substrate in the first processing chamber;
unloading a second substrate from the second processing chamber.

16. The method of claim 15, wherein alternately pumping comprises:
loading a third substrate into the second processing chamber;
closing the first isolation valve in the first vacuum line;
opening the second isolation valve in the second vacuum line;
pumping down the second processing chamber with the pump after completing the processing of the first substrate; and
processing the third substrate in the second processing chamber.

17. The method of claim 17, wherein said unloading a second substrate, and loading a third substrate are performed simultaneously with said pumping down the first processing chamber with the pump.
